(19) United States
(12) Patent Application Publication
(10) Pub. No.: US 2023/0153635 A1
(43) Pub. Date: May 18, 2023

(54) SYSTEMS AND METHODS FOR DATA AGGREGATION AND PREDICTIVE MODELING

(71) Applicant: Capital One Services, LLC, McLean, VA (US)

(72) Inventors: Viraj CHAUDHARY, Katy, TX (US); Isaac YI, Arlington, VA (US); Lin Ni Lisa CHENG, New York, NY (US); Daniel John MARSCH, Sterling, VA (US); Allison FENICHEL, Brooklyn, NY (US); Jacob BALGOYEN, Spotsylvania, VA (US)

(21) Appl. No.: 17/529,047

(22) Filed: Nov. 17, 2021

(51) Int. Cl. G06N 5/02

(52) U.S. Cl. CPC G06N 5/02

(57) ABSTRACT

Systems and methods for secure prediction can include a memory and a processor that is configured to retrieve location information associated with a user account and calculate an average spend over one or more route options for a first period of time based on the location information. The processor can be configured to apply a predictive model to the average spend to determine a predicted utilization amount, identify one or more users that have a user utilization amount exceeding the predicted utilization amount, transmit one or more notifications to adjust the user utilization amount from a first value to a second value for a second period of time, and receive one or more responses that are responsive to the one or more notifications. The processor can be configured to adjust the user utilization amount to the second value and revert the user utilization amount back to the first value.

### FIELD OF THE DISCLOSURE

The present disclosure relates to systems and methods for aggregating data and performing predictive modeling.

### BACKGROUND

Users often engage in activities that involve some degree of planning during daily life. Users occasionally engage in activities that are different than daily life and that require increased planning, such as traveling. However, it is often difficult for users to predict future actions, especially when future actions can be impacted by unforeseen events, during daily life. This difficulty increases when users are engaged in activities that are different than daily life. Accordingly, there is a need to assist users, and the entities users engage with, to better plan for future actions and to handle unforeseen events.

An opportunity to assist users, and the entities users engage with, exists in the increasing amount of data that is becoming available. By properly analyzing available data, improved planning and handling of unforeseen events can be achieved. However, currently available data is often dispersed among a number of data sources, which makes obtaining the available data difficult. In addition, since there is often a large volume of available data and the data available is often complex, analyzing the data, drawing conclusions from the data, and generating useful predictions based on the data, is difficult.

These and other deficiencies exist. Accordingly, there is a need to develop methods of aggregating data and performing predictive modeling to improve planning and the handling of unforeseen events.

### SUMMARY OF THE DISCLOSURE

Embodiments of the present disclosure provide an artificial intelligence (AI) system, method, and a non-transitory computer-accessible medium having stored thereon computer-executable instructions for event predications. Exemplary embodiments can include a data storage containing event data, user messages, user activity data, transaction data, and user identification information; a communication interface in data communication with the data storage; an AI engine in data communication with the data storage and coupled to an application programming interface (API) that enables transmission of real time data through the communication interface; and a natural language processing (NLP) module in data communication with the AI engine. The AI engine can be configured to receive, from the data storage, the user identification information, the user messages, the event data, the user activity data, the transaction data, and the user identification information; scrape webpages for additional event data, apply the NLP module to process the event data; construct user preference data from the user messages, user activity data, transaction data, and user identification information; construct a user profile from a plurality of user preference data; construct a training data set using the processed event data; train a predictive model using the training data set to determine upcoming event predictions; and determine to display one of the upcoming event predictions based on the user profile. If it is determined to display one of the upcoming event predictions, the AI engine can generate a graphical user interface display with a calendar depicting the one of the determined event predictions; and present the graphical user interface display to the user.

Further exemplary embodiments include that the user messages contain at least one selected from the group of sale dates, sale amounts, discounts, and brand names. In addition the user activity data can contain one of merchant names and product names. Further, the user activity data is retrieved from a web scraping module.

In additional exemplary embodiments the AI engine can be configured to perform cluster analysis on the processed event data and determine a confidence score indicative of a likelihood of an occurrence of the determined upcoming event predictions. Further, the predictive model can include at least one selected from the group of a hidden Markov model, a Gaussian mixture model, a pattern matching algorithm, a neural network, a matrix representation, a vector quantization and decision tree, a supervised learning model, an unsupervised learning model, a semi-supervised learning model, a reinforcement learning model, a self-learning model, and a feature learning model.

In further additional exemplary embodiments, the AI engine is also configured to analyze event data associated with competing entities. The user profile can also be constructed with a recommendation engine implementing matrix factorization. The NLP module can implement text recognition, word segmentation, and semantic parsing. The AI engine can also be further configured to provide a web scraping module configured to retrieve and store product and brand information from receipts contained in a user's email account, and to present the web scraping module to the user.

Embodiments of the present disclosure provide a secure prediction system. The secure prediction system can include a memory and a processor. The processor can be configured to retrieve location information associated with a user account. The processor can be configured to calculate an average spend over one or more route options for a first period of time based on the location information. The processor can be configured to apply a predictive model to the average spend to determine a predicted utilization amount. The processor can be configured to identify one or more users that have a user utilization amount exceeding the predicted utilization amount. The processor can be configured to transmit one or more notifications to adjust the user utilization amount from a first value to a second value for a second period of time. The processor can be configured to receive one or more responses that are responsive to the one or more notifications. The processor can be configured to adjust the user utilization amount to the second value. The processor can be configured to revert the user utilization amount back to the first value.

Embodiments of the present disclosure provide a method for secure prediction. The method can include retrieving, by a processor, location information associated with a user account. The method can include calculating, by the processor, an average spend over one or more route options for a first period of time based on the location information. The method can include applying, by the processor, a predictive model to the average spend to determine a predicted utilization amount. The method can include identifying, by the processor, one or more users that have a user utilization amount exceeding the predicted utilization amount. The method can include transmitting, by the processor, one or more notifications to adjust the user utilization amount from a first value to a second value for a second period of time. The method can include receiving, by the processor, one or more responses that are responsive to the one or more notifications. The method can include adjusting, by the processor, the user utilization amount to the second value. The method can include reverting, by the processor, the user utilization amount back to the first value.

Embodiments of the present disclosure provide a computer readable non-transitory medium comprising computer-executable instructions that are executed on a processor and comprising the steps of: retrieving location information associated with a user account; calculating an average spend over one or more route options for a first period of time based on the location information; applying a predictive model to the average spend to determine a predicted utilization amount; identifying one or more users that have a user utilization amount exceeding the predicted utilization amount; transmitting one or more notifications to adjust the user utilization amount from a first value to a second value for a second period of time; receiving one or more responses that are responsive to the one or more notifications; adjusting the user utilization amount to the second value; and reverting the user utilization amount back to the first value.

These and other objects, features, and advantages of the exemplary embodiments of the present disclosure will become apparent upon reading the following detailed description of the exemplary embodiments of the present disclosure when taken in conjunction with the appended claims.

### BRIEF DESCRIPTION OF THE DRAWINGS

Various embodiments of the present disclosure, together with further objects and advantages, can best be understood by reference to the following description taken in conjunction with the accompanying drawings.

FIG. 1 depicts a system according to an exemplary embodiment.

FIG. 2 depicts an artificial intelligence system according to an exemplary embodiment.

FIG. 3 is a sequence diagram illustrating an exemplary process for collecting data and notifying the user accordingly.

FIG. 4 is a method diagram illustrating an exemplary process for collecting a user's data and applying predictive models in order to generate results.

FIG. 5 is a sequence diagram illustrating an exemplary embodiment for adjusting a user's utilization amount based on the location information retrieved by the processor.

FIG. 6 is a method diagram illustrating an exemplary process for notifying the user and adjusting the user's utilization amount accordingly.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The present disclosure is directed to systems and methods of data aggregation and predictive modeling. Example embodiments provide for aggregation of data from various sources and artificial intelligence (AI) systems for generating and applying predictive models to anticipate future user actions.

Example embodiments provide systems and methods for predicting user actions, including future spending by a user. For example, a user associated with an account, such as a credit card account, can generate a transaction history through his or her typical use of the account. However, the user's transaction history cannot be readily applicable to non-typical situations, including without limitation travel and vacations, and time periods include non-typical situations can require additional spending. Non-typical situations can also encounter disruptions, such as travel disruptions, transportation changes or cancellations (e.g., flight delays and cancellations), and other unforeseen disruptions, which can further differentiate the non-typical situation from situations in which the user usually engages. For at least these reasons, non-typical situations can result in additional spending needs for users.

Systems and methods of the present disclosure provide for data aggregation and AI-based predictions for upcoming events, including typical and non-typical events. When a user engages in a non-typical event and/or encounters a disruption, example embodiments of the present disclosure can generate predictions of future events and needs, such as future spending needs for a user's credit account, to better accommodate the user's upcoming needs with responsive actions (e.g., an increased credit limit, increased fraud protection).

Benefits of the present disclosure include increased anticipation and adaptability to user needs. For example, an entity issuing a credit account can increase or decrease a credit limit in view of the anticipated needs, to allow the user to access additional credit when needed. The present disclosure provides an efficient way to adjust a credit limit prior to a request by the user. This eliminate the need for a user to call the issuing entity or otherwise and manually submit a request for a credit limit increase, which conserves the entity's resources and reduces the need for the entity to devote employee time for receiving, evaluating, and granting a request.

In addition, since the credit limit increase can be temporary, the present disclosure can conserve additional resources that would otherwise be expended in evaluating whether the credit increase remains necessary. Similarly, resources can be conserved in determining when the credit limit increase can be rescinded and in rescinding the credit limit increase.

In addition, the user can benefit from receiving a credit increase in anticipation of increased need for credit. By anticipating the need for a credit increase and providing the credit increase without the need for the user to request it, the user does not have to call or manually submit call the issuing entity or otherwise and manually submit a request for a credit limit increase.

By anticipating the need for a credit limit increase and granting the increase prior to the user requesting it, a potentially unpleasant situation where the user lacks sufficient credit to complete a transaction can be avoided. Avoiding such a situation can be a benefit to the user and knowing such a situation can be avoided can result in increased peace of mind for the user. The issuing entity can benefit by avoiding having its customer encounter an unpleasant situation. These benefits can be particularly important as the user experiences a non-typical situation and/or a disruption.

It is understood that some users cannot prefer to receive a credit limit increase and the issuing entity can only apply the systems and methods of the present disclosure to users that have opted-in to receive such a credit limit increase. If a user prefers not to participate or be considered for or receive a credit limit increase in this manner, or does not affirmative opt-in to become eligible, the systems and methods of the present disclosure would not be applied to such a user.

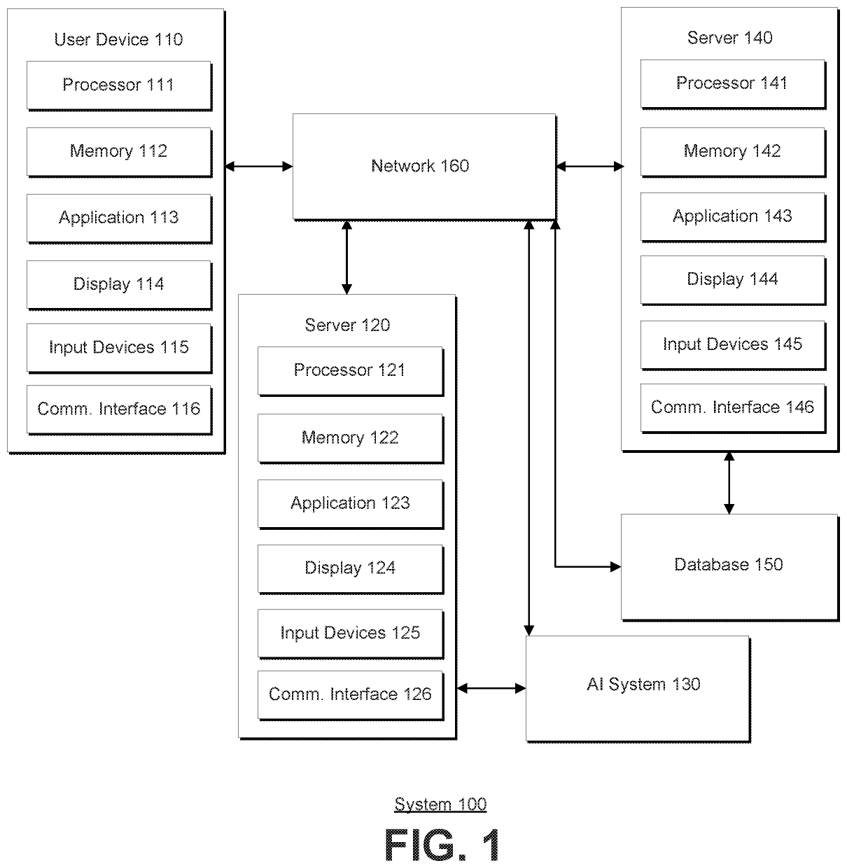

FIG. 1 illustrates a system for data aggregation and predictive modeling 100 according to an example embodiment. As shown in FIG. 1, the system 100 can include a user device 110, a server 120, an AI system 130, a server 140, a database 150, and a network 160.

The user device 110 can include one or more one or more processors 111 and one or more memories 112. Memory 112 can include one or more applications, such as application 113. The user device 110 can be in data communication with any number of components of system 100. For example, the user device 110 can transmit data via network 160 to server 120. As another example, the user device 110 can transmit data via network 160 to server 140. As another example, the user device 110 can transmit data via network 160 to AI system 130. As another example, the user device 110 can transmit data via network 160 to database 150.

Without limitation, the user device 110 can be a network-enabled computer. As referred to herein, a network-enabled computer can include, without limitation, a computer device or communications device including, e.g., a server, a network appliance, a personal computer, a workstation, a phone, a handheld PC, a personal digital assistant, a contactless card, a thin client, a fat client, an Internet browser, a kiosk, a tablet, a terminal, an automated teller machine (ATM), or other device. The user device 110 also can be a mobile device; for example, a mobile device can include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The processor 111 can be a processor, a microprocessor, or other processor, and the user device 110 can include one or more of these processors. The processor 111 can include processing circuitry, which can contain additional components, including additional processors, memories, error and parity/CRC checkers, data encoders, anti-collision algorithms, controllers, command decoders, security primitives and tamper-proofing hardware, as necessary to perform the functions described herein.

The processor 111 can be coupled to the memory 112. The memory 112 can be a read-only memory, write-once read-multiple memory or read/write memory, e.g., RAM, ROM, and EEPROM, and the user device 110 can include one or more of these memories. A read-only memory can be factory programmable as read-only or one-time programmable. One-time programmability provides the opportunity to write once then read many times. A write-once read-multiple memory can be programmed at a point in time after the memory has left the factory. Once the memory is programmed, it cannot be rewritten, but it can be read many times. A read/write memory can be programmed and re-programed many times after leaving the factory. It can also be read many times. The memory 112 can be configured to store one or more software applications, such as the application 113, and other data, such as user's private data and financial account information. The memory 112 can be a non-transitory memory.

The application 113 can comprise one or more software applications, such as a mobile application, a web browser, and a browser extension, comprising instructions for execution on the user device 110. In some examples, the user device 110 can execute one or more applications, such as software applications, that enable, for example, network communications with one or more components of the system 100, the transmission and/or receipt of data, and the performance of the functions described herein. Upon execution by the processor 111, the application 113 can provide the functions described in this specification, specifically to execute and perform the steps and functions in the process flows described herein. Such processes can be implemented in software, such as software modules stored on non-transitory computer media, for execution by computers or other machines. The application 113 can provide graphical user interfaces (GUIs) through which a user can view and interact with other components and devices within the system 100. The GUIs can be formatted, for example, as web pages in HyperText Markup Language (HTML), Extensible Markup Language (XML) or in any other suitable form for presentation on a display device depending upon applications used by users to interact with the system 100.

The user device 110 can further include a display 114 and input devices 115. The display 114 can be one or more of any type of device for presenting visual information such as a computer monitor, a flat panel display, a touch screen display, a kiosk display, an ATM display, and a mobile device screen. Exemplary displays can include, without limitation, at least one selected from the group of liquid crystal displays, light-emitting diode displays, plasma panels, and cathode ray tube displays. The input devices 115 can include one or more of any device for entering information into the user device 110 that is available and supported by the user device 110. Exemplary input devices can include, without limitation, one or more selected from the group of a keyboard, a mouse, a touch screen, a stylus, a joystick, a trackball, a dial, and an eye gaze tracker, a joypad, a pointing stick, a touch pad, a three-dimensional mouse, a light pen, a dial, a knob, a gesture recognition input device, a sip-and-puff input device, a microphone, a digital camera, a video recorder, and a camcorder. The input devices 115 can be used to enter information and interact with the user device 110 and by extension with the systems and software described herein.

The user device 110 can further include a communication interface 116 having wired and/or wireless data communication capabilities. These capabilities can support data communication with a wired and/or wireless communication network, including the Internet, a cellular network, a wide area network, a local area network, a wireless personal area network, a wide body area network, any other wired or wireless network for transmitting and receiving a data signal, or any combination thereof. This network can include, without limitation, telephone lines, fiber optics, IEEE Ethernet 902.3, a wide area network, a local area network, a wireless personal area network, a wide body area network or a global network such as the Internet. The communication interface 116 can also support a short-range wireless communication interface, such as near field communication, radio-frequency identification, and Bluetooth.

The server 120 can include one or more one or more processors 121 and one or more and memories 122. The memory 122 can include one or more applications, such as the application 123. The server 120 can be in data communication with any number of components of system 100. For example, the server 120 can transmit data via network 160 to server 120. As another example, the server 120 can transmit data via network 160 to server 140. As another example, the server 120 can transmit data via network 160 to AI system 130. As another example, the server 120 can transmit data via network 160 to database 150.

Without limitation, the server 120 can be a network-enabled computer. As referred to herein, a network-enabled computer can include, without limitation, a computer device or communications device including, e.g., a server, a network appliance, a personal computer, a workstation, a phone, a handheld PC, a personal digital assistant, a contactless card, a thin client, a fat client, an Internet browser, a kiosk, a tablet, a terminal, an automated teller machine (ATM), or other device. The server 120 also can be a mobile device; for example, a mobile device can include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

In some examples, server 120 can be a dedicated server computer or a bladed server. In some examples, the server 120 can be configured as a central system, server, or platform to control and call various data at different times. While FIG. 1 illustrates a single server 120, it is understood that other embodiments can use multiple servers or multiple computer systems as necessary or desired to support the users and can also use back-up or redundant servers to prevent network downtime in the event of a failure of a particular server.

The processor 121 can be a processor, a microprocessor, or other processor, and the server 120 can include one or more of these processors. The processor 121 can include processing circuitry, which can contain additional components, including additional processors, memories, error and parity/CRC checkers, data encoders, anti-collision algorithms, controllers, command decoders, security primitives and tamper-proofing hardware, as necessary to perform the functions described herein.

The processor 121 can be coupled to the memory 122. The memory 122 can be a read-only memory, write-once read-multiple memory or read/write memory, e.g., RAM, ROM, and EEPROM, and the server 120 can include one or more of these memories. A read-only memory can be factory programmable as read-only or one-time programmable. One-time programmability provides the opportunity to write once then read many times. A write-once read-multiple memory can be programmed at a point in time after the memory has left the factory. Once the memory is programmed, it cannot be rewritten, but it can be read many times. A read/write memory can be programmed and re-programed many times after leaving the factory. It can also be read many times. The memory 122 can be configured to store one or more software applications, such as the application 123, and other data, such as user's private data and financial account information. The memory 122 can be a non-transitory memory.

The application 123 can comprise one or more software applications, such as a mobile application, a web browser, and a browser extension, comprising instructions for execution on the server 120. In some examples, the server 120 can execute one or more applications, such as software applications, that enable, for example, network communications with one or more components of the system 100, the transmission and/or receipt of data, and the performance of the functions described herein. Upon execution by the processor 121, the application 123 can provide the functions described in this specification, specifically to execute and perform the steps and functions in the process flows described herein. Such processes can be implemented in software, such as software modules stored on non-transitory computer media, for execution by computers or other machines. The application 123 can provide graphical user interfaces (GUIs) through which a user can view and interact with other components and devices within the system 100. The GUIs can be formatted, for example, as web pages in HyperText Markup Language (HTML), Extensible Markup Language (XML) or in any other suitable form for presentation on a display device depending upon applications used by users to interact with the system 100.

The server 120 can further include a display 124 and input devices 125. The display 124 can be one or more of any type of device for presenting visual information such as a computer monitor, a flat panel display, a touch screen display, a kiosk display, an ATM display, and a mobile device screen. Exemplary displays can include, without limitation, at least one selected from the group of liquid crystal displays, light-emitting diode displays, plasma panels, and cathode ray tube displays. The input devices 125 can include one or more of any device for entering information into the server 120 that is available and supported by the user device 110. Exemplary input devices can include, without limitation, one or more selected from the group of a keyboard, a mouse, a touch screen, a stylus, a joystick, a trackball, a dial, and an eye gaze tracker, a joypad, a pointing stick, a touch pad, a three-dimensional mouse, a light pen, a dial, a knob, a gesture recognition input device, a sip-and-puff input device, a microphone, a digital camera, a video recorder, and a camcorder. The input devices 125 can be used to enter information and interact with the server 120 and by extension with the systems and software described herein.

The server 120 can further include a communication interface 126 having wired and/or wireless data communication capabilities. These capabilities can support data communication with a wired and/or wireless communication network, including the Internet, a cellular network, a wide area network, a local area network, a wireless personal area network, a wide body area network, any other wired or wireless network for transmitting and receiving a data signal, or any combination thereof. This network can include, without limitation, telephone lines, fiber optics, IEEE Ethernet 902.3, a wide area network, a local area network, a wireless personal area network, a wide body area network or a global network such as the Internet. The communication interface 126 can also support a short-range wireless communication interface, such as near field communication, radio-frequency identification, and Bluetooth.

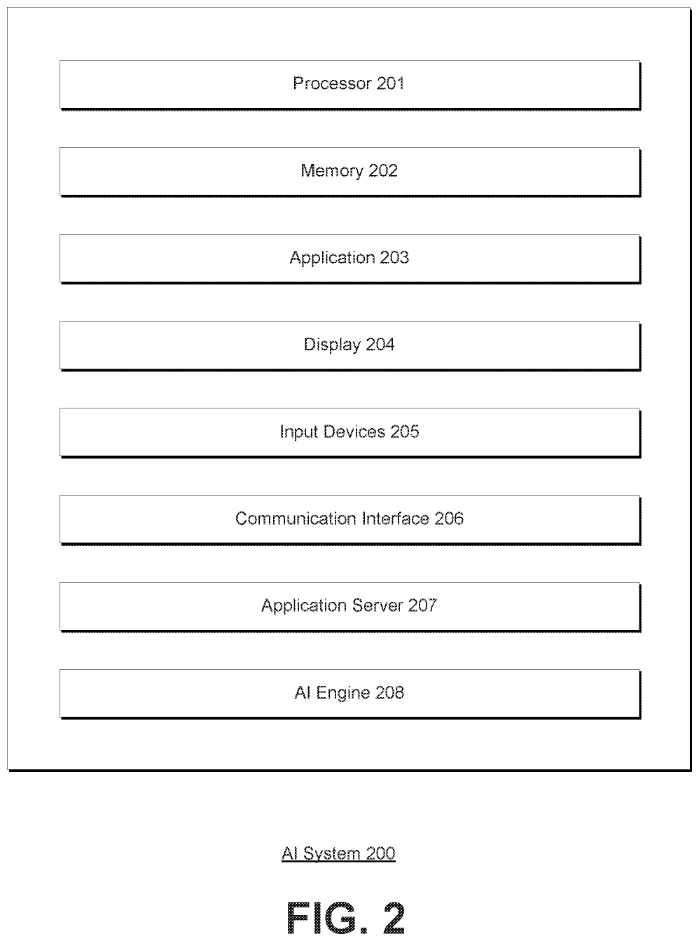

The AI system 130 can be can be developed by one or more machine learning algorithms and generate one or more predictive models. In some examples, the machine learning algorithms employed can include at least one selected from the group of gradient boosting machine, logistic regression, neural networks, and a combination thereof, however, it is understood that other machine-learning algorithms can be utilized. Further description of AI system 130 is provided with reference to FIG. 2.

In some examples, the AI system 130 can be contained within the server 120, such as within the memory 122 of the server 120. In other examples, the AI system 130 can be remote from the server 120, but in data communication with the server 120. Data communication between the AI system 130 and the server 120 can be a direct data communication or data communication via a network, such as the network 160.

The server 140 can include one or more one or more processors 141 and one or more and memories 142. The memory 142 can include one or more applications, such as application 143. The server 140 can be in data communication with any number of components of system 100. For example, the server 140 can transmit data via network 160 to server 140. As another example, the server 140 can transmit data via network 160 to server 140. As another example, the server 140 can transmit data via network 160 to AI system 130. As another example, the server 140 can transmit data via network 160 to database 150.

Without limitation, the server 140 can be a network-enabled computer. As referred to herein, a network-enabled computer can include, without limitation, a computer device or communications device including, e.g., a server, a network appliance, a personal computer, a workstation, a phone, a handheld PC, a personal digital assistant, a contactless card, a thin client, a fat client, an Internet browser, a kiosk, a tablet, a terminal, an automated teller machine (ATM), or other device. The server 140 also can be a mobile device; for example, a mobile device can include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

In some examples, server 140 can be a dedicated server computer or a bladed server. In some examples, the server 140 can be configured as a central system, server, or platform to control and call various data at different times. While FIG. 1 illustrates a single server 140, it is understood that other embodiments can use multiple servers or multiple computer systems as necessary or desired to support the users and can also use back-up or redundant servers to prevent network downtime in the event of a failure of a particular server.

The processor 141 can be a processor, a microprocessor, or other processor, and the server 140 can include one or more of these processors. The processor 141 can include processing circuitry, which can contain additional components, including additional processors, memories, error and parity/CRC checkers, data encoders, anti-collision algorithms, controllers, command decoders, security primitives and tamper-proofing hardware, as necessary to perform the functions described herein.

The processor 141 can be coupled to the memory 142. The memory 142 can be a read-only memory, write-once read-multiple memory or read/write memory, e.g., RAM, ROM, and EEPROM, and the server 140 can include one or more of these memories. A read-only memory can be factory programmable as read-only or one-time programmable. One-time programmability provides the opportunity to write once then read many times. A write-once read-multiple memory can be programmed at a point in time after the memory has left the factory. Once the memory is programmed, it can not be rewritten, but it can be read many times. A read/write memory can be programmed and re-programed many times after leaving the factory. It can also be read many times. The memory 142 can be configured to store one or more software applications, such as the application 143, and other data, such as user's private data and financial account information. The memory 142 can be a non-transitory memory.

The application 143 can comprise one or more software applications, such as a mobile application, a web browser, and a browser extension, comprising instructions for execution on the server 140. In some examples, the server 140 can execute one or more applications, such as software applications, that enable, for example, network communications with one or more components of the system 100, the transmission and/or receipt of data, and the performance of the functions described herein. Upon execution by the processor 141, the application 143 can provide the functions described in this specification, specifically to execute and perform the steps and functions in the process flows described herein. Such processes can be implemented in software, such as software modules stored on non-transitory computer media, for execution by computers or other machines. The application 143 can provide graphical user interfaces (GUIs) through which a user can view and interact with other components and devices within the system 100. The GUIs can be formatted, for example, as web pages in HyperText Markup Language (HTML), Extensible Markup Language (XML) or in any other suitable form for presentation on a display device depending upon applications used by users to interact with the system 100.

The server 140 can further include a display 144 and input devices 145. The display 144 can be one or more of any type of device for presenting visual information such as a computer monitor, a flat panel display, a touch screen display, a kiosk display, an ATM display, and a mobile device screen. Exemplary displays can include, without limitation, at least one selected from the group of liquid crystal displays, light-emitting diode displays, plasma panels, and cathode ray tube displays. The input devices 145 can include one or more of any device for entering information into the server 140 that is available and supported by the user device 110. Exemplary input devices can include, without limitation, one or more selected from the group of a keyboard, a mouse, a touch screen, a stylus, a joystick, a trackball, a dial, and an eye gaze tracker, a joypad, a pointing stick, a touch pad, a three-dimensional mouse, a light pen, a dial, a knob, a gesture recognition input device, a sip-and-puff input device, a microphone, a digital camera, a video recorder, and a camcorder. The input devices 145 can be used to enter information and interact with the server 140 and by extension with the systems and software described herein.

The server 140 can further include a communication interface 146 having wired and/or wireless data communication capabilities. These capabilities can support data communication with a wired and/or wireless communication network, including the Internet, a cellular network, a wide area network, a local area network, a wireless personal area network, a wide body area network, any other wired or wireless network for transmitting and receiving a data signal, or any combination thereof. This network can include, without limitation, telephone lines, fiber optics, IEEE Ethernet 902.3, a wide area network, a local area network, a wireless personal area network, a wide body area network or a global network such as the Internet. The communication interface 146 can also support a short-range wireless communication interface, such as near field communication, radio-frequency identification, and Bluetooth.

The database 150 can comprise one or more databases. Exemplary databases can include, without limitation, relational databases, non-relational databases, hierarchical databases, object-oriented databases, network databases, and any combination thereof. The database 150 can be centralized or distributed. The database 150 can be hosted internally by any component of system 100, or the database 150 can be hosted externally to any component of the system 100. In some examples, the database 150 can be contained in the user device 110, the server 120, the AI system 130, and/or the server 140, and in other examples the database can be stored outside of the user device 110, the server 120, the AI system 130, and the server 140 but in data communication with the user device 110, the server 120 and the server 140. The database 150 can be implemented in a database programming language. Exemplary database programming languages include, without limitation, Structured Query Language (SQL), My SQL, HyperText Markup Language, JavaScript, Hypertext Preprocessor Language, Practical Extraction and Report Language, Extensible Markup Language, and Common Gateway Interface. Queries made to the database 150 can be implemented in the same database programming language used to implement database 150. For example, if database 150 is an SQL database, then queries made to the database can be made in SQL (e.g., SELECT column1, column2 FROM table1, table2 WHERE column2=‘value’). It is understood that database 150 can be implemented in any database programming language and that the programming implementation of the query can be adjusted as necessary for compatibility with the database 150 and to reflect the particular information to be queried.

In some examples, the database 150 can be contained within the server 140, such as within the memory 142 of the server 140. In other examples, the database 150 can be remote from the server 140, but in data communication with the server 140. Data communication between the database 150 and the server 140 can be a direct data communication or data communication via a network, such as the network 160.

The network 160 can be one or more of a wireless network, a wired network, or any combination of wireless network and wired network, and can be configured to connect components of system 100. For example, network 160 can include one or more of a fiber optics network, a passive optical network, a cable network, an Internet network, a satellite network, a wireless local area network (LAN), a Global System for Mobile Communication, a Personal Communication Service, a Personal Area Network, a Wireless Personal Area Network, a Wide Body Area Network, Wireless Application Protocol, Multimedia Messaging Service, Enhanced Messaging Service, Short Message Service, Time Division Multiplexing based systems, Code Division Multiple Access based systems, IEEE Ethernet 902.3, D-AMPS, Wi-Fi, Fixed Wireless Data, IEEE 802.11b, 802.15.1, 802.11n and 802.11g, Bluetooth, NFC, Radio Frequency Identification (RFID), and/or the like. In some examples, the network 160 can be the Internet.

In addition, the network 160 can include, without limitation, telephone lines, fiber optics, IEEE Ethernet 902.3, a wide area network, a wireless personal area network, a LAN, or a global network such as the Internet. In addition, network 160 can support an Internet network, a wireless communication network, a cellular network, or the like, or any combination thereof Network 160 can further include one network, or any number of the exemplary types of networks mentioned above, operating as a stand-alone network or in cooperation with each other. Network 160 can utilize one or more protocols of one or more network elements to which they are communicatively coupled. Network 160 can translate to or from other protocols to one or more protocols of network devices. Although network 160 is depicted as a single network, it should be appreciated that according to one or more examples, network 160 can comprise a plurality of interconnected networks, such as, for example, the Internet, a service provider's network, a cable television network, corporate networks, such as credit card association networks, and home networks.

In some examples, exemplary procedures in accordance with the present disclosure described herein can be performed by a processing arrangement and/or a computing arrangement (e.g., computer hardware arrangement). Such processing/computing arrangement can be, for example entirely or a part of, or include, but not limited to, a computer device (e.g., a network-enabled computer) and/or a processor that can include, for example one or more microprocessors, and use instructions stored on a non-transitory computer-accessible medium (e.g., RAM, ROM, hard drive, or other storage device). For example, a computer-accessible medium can be part of the memory of the user device 110, the server 120, and/or the server 140, or other computer hardware arrangement.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

In some examples, one component of system 100 can collect data from one or more other components. For example, the user device 110, the server 120 and/or the AI system 130 can collect data from the server 140 and the database 150. For example, an application, such as a web browser, web crawler, or native mobile application, can initiate communications by making a request for a specific resource using HTTP/HTTPS and the server 140 and the database 150 can respond with the content of that resource or an error message if unable to do so. The resource can be, for example a file on stored by the server 140 and the database 150. The server 140 and the database 150 also can enable or facilitate receiving content from the user device 110, the server 120, and the AI system 130 so the user device 110, the server 120, and the AI system 130 can submit requests for data. As another example, data can be collected a screen scraper, an application programming interface (API), or other methods. The data can be scraped periodically without requiring an event to prompt it. For example, the data can be scraped hourly, daily, weekly or monthly. Data obtained by the user device 110 and server 120 can be supplied to the AI system 130 and stored in the database 150, as can data obtained by the AI system 130.

A variety of data can be collected and used for predictive modeling. Exemplary data obtained can include, without limitation, transportation data, transaction data, and activity data. For example, transportation data can comprise data relating to flights, trains, buses, ships, personal cars, and rental cars, including without limitation, schedules, ticketing, reservations, status (e.g., on time, delayed, departed arrived), status of journey (e.g., current location, progress made, time remaining until destination is reached), disruptions (e.g., type, date and time, duration, location, impact, adverse consequences and severity, and logs thereof), and passenger identification and logs, for both transportation that is currently underway and for past transportation activity. As another example, transaction data can include data relating to credit card, debit card, gift card, and cash transactions including, without limitation, merchant identification, merchant location, goods and services transacted for, payment amount, payment method, payment account, customer identification (e.g., user name, billing and shipping address, account number), date and time of transaction, returns, refunds, credits, extra charges, and reviews of the transaction. As another example, activity data can include data relating to an event engaged in, or viewed by, a user, such as a sporting activity, a work activity, a recreational activity, a social activity, a sporting event, a concert, and a festival.

Example embodiments provide for the collection of current, recent, and past data. The time period for which data can be collected can be varied based on the intended application of the data and relevant time period. In some examples, the data can for a short time, such as an hour, a day, a week, or a month, and in other examples, the data can be for a longer time, such as a multiple months, a year, or multiple years. For example, transportation data collected for purposes of predictive modeling the impact of a disruption can be relatively recent to focus on the immediate effects of the disruption, or data over a longer period can be collected but the more recent data can be weighted more heavily. As another example, the data collected can be for a time period sufficient to include one or more instances of the same or similar disruption, transportation, transaction, or activity.

As another example, data collected for purposes of training and developing predictive models, can be over a longer time period. In other examples, continuous or incremental predictive model training and development can require data collected over a smaller and targeted time period. Data collected for this purpose can be updated and supplemented periodically. In some examples, a threshold for data collection can be established to ensure the collection of a sufficient amount of relevant data, such as one or more instances of the same or similar event. Exemplary thresholds for data collection can include, without limitation, one instance of an event, multiple instances of an event, or a dynamic threshold that changes as data is collected. The threshold can be established by predictive modeling according to the systems and methods described herein.

FIG. 2 illustrates an AI system according to an example embodiment. FIG. 2 can reference the same or similar components as illustrated in FIG. 1. As shown in FIG. 2, the AI system 200 can include a processor 201, a memory 202, an application 203, a display 204, inputs devices 205, a communication interface 206, an application server 207, and an AI engine 208.

The processor 201 can be a processor, a microprocessor, or other processor, and the AI system 200 can include one or more of these processors. The processor 201 can include processing circuitry, which can contain additional components, including additional processors, memories, error and parity/CRC checkers, data encoders, anti-collision algorithms, controllers, command decoders, security primitives and tamper-proofing hardware, as necessary to perform the functions described herein.

The processor 201 can be coupled to the memory 202. The memory 202 can be a read-only memory, write-once read-multiple memory or read/write memory, e.g., RAM, ROM, and EEPROM, and the AI system 200 can include one or more of these memories. A read-only memory can be factory programmable as read-only or one-time programmable. One-time programmability provides the opportunity to write once then read many times. A write-once read-multiple memory can be programmed at a point in time after the memory has left the factory. Once the memory is programmed, it cannot be rewritten, but it can be read many times. A read/write memory can be programmed and re-programed many times after leaving the factory. It can also be read many times. The memory 202 can be configured to store one or more software applications, such as the application 203, and other data, such as user's private data and financial account information. The memory 202 can be a non-transitory memory.

The application 203 can comprise one or more software applications, such as a mobile application, a web browser, and a browser extension, comprising instructions for execution on the AI system 200. In some examples, the AI system 200 can execute one or more applications, such as software applications, that enable, for example, network communications, the transmission and/or receipt of data, and the performance of the functions described herein. Upon execution by the processor 201, the application 203 can provide the functions described in this specification, specifically to execute and perform the steps and functions in the process flows described herein. Such processes can be implemented in software, such as software modules stored on non-transitory computer media, for execution by computers or other machines. The application 203 can provide graphical user interfaces (GUIs) through which a user can view and interact with the AI system 200. The GUIs can be formatted, for example, as web pages in HyperText Markup Language (HTML), Extensible Markup Language (XML) or in any other suitable form for presentation on a display device depending upon applications used by users to interact with the AI system 200.

The AI system 200 can further include a display 204 and input devices 205. The display 204 can be one or more of any type of device for presenting visual information such as a computer monitor, a flat panel display, a touch screen display, a kiosk display, an ATM display, and a mobile device screen. Exemplary displays can include, without limitation, at least one selected from the group of liquid crystal displays, light-emitting diode displays, plasma panels, and cathode ray tube displays. The input devices 205 can include one or more of any device for entering information into the AI system 200 that is available and supported by the AI system 200. Exemplary input devices can include, without limitation, one or more selected from the group of a keyboard, a mouse, a touch screen, a stylus, a joystick, a trackball, a dial, and an eye gaze tracker, a joypad, a pointing stick, a touch pad, a three-dimensional mouse, a light pen, a dial, a knob, a gesture recognition input device, a sip-and-puff input device, a microphone, a digital camera, a video recorder, and a camcorder. The input devices 205 can be used to enter information and interact with the AI system 200 and by extension with the systems and software described herein.

The AI system 200 can further include a communication interface 206 having wired and/or wireless data communication capabilities. These capabilities can support data communication with a wired and/or wireless communication network, including the Internet, a cellular network, a wide area network, a local area network, a wireless personal area network, a wide body area network, any other wired or wireless network for transmitting and receiving a data signal, or any combination thereof. This network can include, without limitation, telephone lines, fiber optics, IEEE Ethernet 902.3, a wide area network, a local area network, a wireless personal area network, a wide body area network or a global network such as the Internet. The communication interface 206 can also support a short-range wireless communication interface, such as near field communication, radio-frequency identification, and Bluetooth.

The AI system 200 can further include an application server 207, which can be the same or similar as the server 120 and the server 140 illustrated in FIG. 1. In some examples, the application server 207 can include hardware and/or software dedicated to the efficient execution of procedures (e.g., programs, routines, scripts) for supporting its applied applications, including the AI and machine learning procedures and functionalities described herein. The application server 207 can comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. The application server 207 can support the construction of dynamic pages. The application server 207 also can implement services, such as, for example, clustering, failover, and load balancing. In various embodiments, where the application server 207 is a Java application server, the application server 207 may behave like an extended virtual machine for running applications, transparently handling connections to databases on one side, and connections to other components of the AI system 200 or components of other systems described herein on the other side.

The AI system 200 can further include an AI engine 208, which can collect data or receive data used for predictive modeling from other devices described herein (e.g., the components of FIG. 1). The collected or received data can include, without limitation, transportation data, transaction data, and activity data. This data can be processed and used to generate and train predictive models. The AI engine 208 can also transmit, or cause transmission of, text messages, emails, API calls or other forms of communication to other devices described herein (e.g., the components of FIG. 1).

In some examples, the AI engine 208 can utilize AI technologies to parse and process the received data to extract conditionally relevant meaning from data. For example, the AI engine 208 can identify and format various fields of data including, without limitation, flight numbers, flight schedules, passenger names, and the like from transportation data, merchant names, account information, good and services transacted for, and the like from transaction data, and user names, activity details, event details, and the like from activity data. The AI engine 208 can utilize natural language processing technologies to process the data to extract conditionally relevant meaning from the data. The AI engine 208 can combine processed data from a single user, merchant, data type, or data source, or a plurality of users, merchants, data types, or data sources, into one or more training datasets for one or more predictive models used to predict and analyze events.

The AI engine 208 can aggregated the data across one or more users, merchants, data types, and data sources. The AI engine 208 can continuously evaluate the aggregated data to determine whether the one or more conditions is met. To minimize system resources, the AI system 200 can store the compressed aggregated data in the memory 202 or in an external data storage (e.g., an external or remote database). The compressed aggregated data can include the associated conditionally relevant meaning verification and associated metadata necessary to establish proof of occurrence of the condition, rather than the raw received input data. For example, the AI engine 208 can automatically determine whether data is consequential by evaluating whether the data is pertinent to determining whether a condition has been met and/or is associated with data that does not satisfy a condition. Inconsequential data can be purged by the AI system 200 to save storage space. For example, transportation, transaction, and/or activity data that is redundant of information already stored in memory 202 or in an external data storage can be purged. Consequential data can include previously processed data, which can be utilized to predict the likelihood of events.

One or more predictive models can be developed by one or more machine learning algorithms and generated by the AI engine 208. In some examples, the machine learning algorithms employed can include at least one selected from the group of gradient boosting machine, logistic regression, neural networks, and a combination thereof, however, it is understood that other machine learning algorithms can be utilized.

For example, to generate predictions pertaining to the likelihood of events and the necessity of taking action in response thereto, one or more predictive models can utilize information relating to the variables described herein. Variables include, without limitation, current and historical collection of the data discussed herein, such as transportation data, transaction data, and activity data, along with the frequency and nature of past events and the correlations associated within the data and past events.

The predictive models described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

Alternatively, the predictive models described herein can utilize various neural networks, such as convolutional neural networks (CNNs) or recurrent neural networks (RNNs), to generate the exemplary models. A CNN can include one or more convolutional layers (e.g., often with a subsampling step) and then followed by one or more fully connected layers as in a standard multilayer neural network. CNNs can utilize local connections, and can have tied weights followed by some form of pooling which can result in translation invariant features.

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. A RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feed forward neural network, while an infinite impulse recurrent network can be, or can include, a directed cyclic graph that can not be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of long short-term memory networks (LSTMs) and gated recurrent units

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

Examples of predictive models that can be implemented further include, without limitation, a hidden Markov model, a Gaussian mixture model, a pattern matching algorithm, a neural network, a matrix representation, (a vector quantization and decision tree, a supervised learning model, an unsupervised learning model, a semi-supervised learning model, a reinforcement learning model, a self-learning model, and a feature learning model.

The predictive models described herein can be trained on one or more training datasets, each of which can comprise one or more types of data. The training data can comprise transportation data, transaction data, activity data, and any combination thereof. In some examples, the training datasets can comprise previously-collected data, such as data collected from previous uses of the same type of systems described herein and data collected from different types of systems. In other examples, the training datasets can comprise continuously-collected data, including continuously collected transportation data, transaction data, activity data, and other data.

In some examples, the training dataset can include anticipated data, such as anticipated transportation data, transaction data, and activity data, and the training dataset can further include results data indicative of the accuracy of the anticipated transportation data, transaction data, and activity data. In accordance with these examples, the predictive models described herein can be training prior to use and the training can continue with updated data sets that reflect additional information.

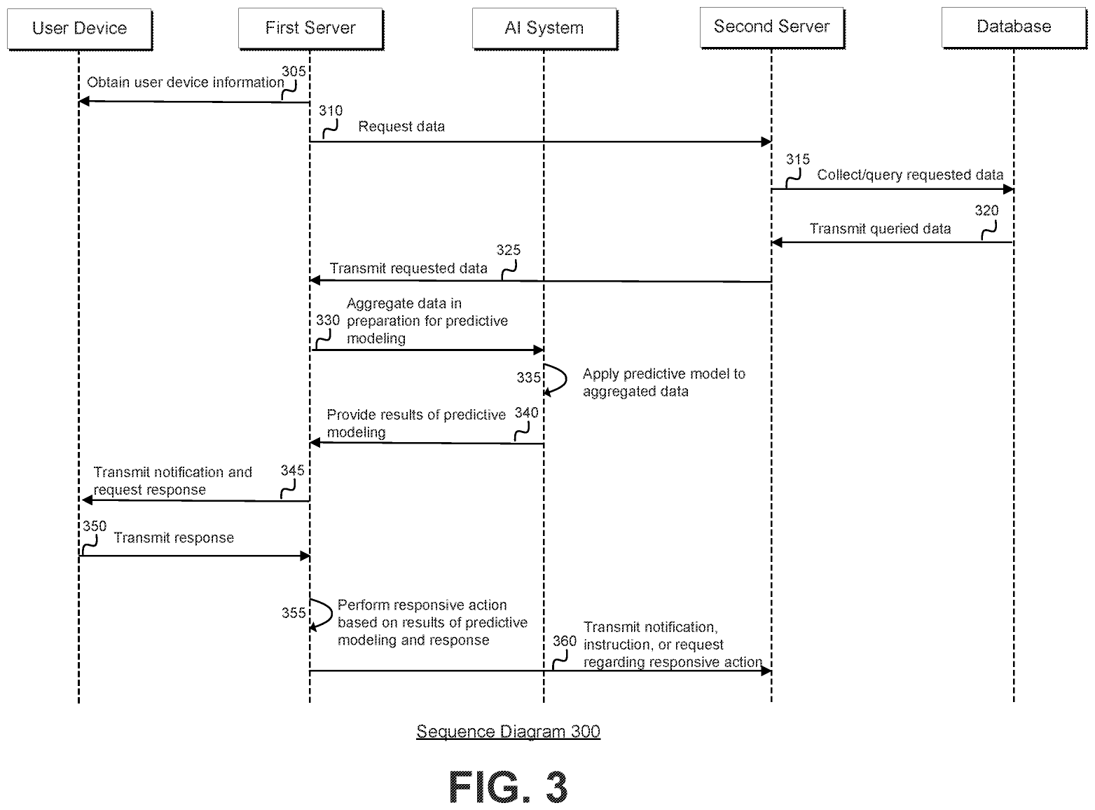

FIG. 3 illustrates a sequence diagram 300 for the operation of a system for data aggregation and predictive modeling. FIG. 3 can reference the same or similar components as illustrated in FIGS. 1 and 2. As shown in FIG. 3, the sequence diagram 300 can include a user device, a first server, an AI system, a second server, and a database in data communication via a network.

The sequence diagram 300 can begin with step 305, where the first server can obtain information from the user device. In some examples, the first server can access and retrieve information stored by the user device, and in other examples, the first server can transmit a request for information to the user device and receive information transmitted by the user device in response to the request. The retrieved and/or requested information can include, without limitation, the location of the user device, identification information of an application executing on the user device, identification of the user device (e.g., device identifier, network identifier), identification of a user associated with the user device, identification of an account associated with the user associated with the user device, any transportation data, transaction data, or activity data stored by the user device, and any combination thereof.

Upon receipt of the retrieved or requested information, in step 310, the first server can request data relevant to the information from the second server. The requested data can include, without limitation, transportation data, transaction data, activity data, and any combination thereof. The requested data can be relevant to the information obtained from the user device, and can be stored by the second server or otherwise accessible to the server, such as data stored in the database. While FIG. 3 illustrates a second server, it is understood that the first server can request relevant data from one server or a plurality of servers or data sources (e.g., databases or other data storages). In some examples, the first server can collect data stored in its memory, including querying one or more databases contained by the first server. In other examples, the first server can directly query one or more databases stored externally from the first server or stored internally by the first server.

In step 315, the second server can collect, and as necessary, query for the requested data. For example, data stored by the second server can be collected by the second server and data stored externally to the second server can be requested. For example, the second server can query one or more databases to collect the requested data, and it is understood that the one or more databases can be contained within the second server or stored externally to the second server. It is also understood that the second server can query one or more other servers as necessary to obtain the requested data. In response to a query, the database can transmit the queried data to the second server in step 320.

Once the requested data is collected, the second server can transmit the requested data to the first server in step 325. It is understood that one server, or a plurality of servers can transmit the requested data to the first server. It is further understood that the first server can directly query one or more databases stored externally from the first server.

In step 330, upon receipt of the requested data, the first server can aggregate the requested data. In some examples, when data is requested from and/or received from various servers, databases, or other data sources, each of which can be operated by the same or different entities, aggregation of the data includes combining the data and structuring the data in a format accessible to the AI system. For example, data can be received as electronic information, files, and documents stored in various ways, including, for example, a flat file, indexed file, hierarchical database, relational database, non-relational database, and other files created and maintained with software from, for example, Oracle® Corporation, Microsoft®, and Apple®. In some examples, the received data can be combined with previously received data. The received data can be combined, formatted, and structured into a form usable by the AI system in preparation for use in predictive model training and/or predictive modeling. Once data collection and aggregation is complete, the aggregated data can be sent to the AI system. In some examples, the data aggregation functions described herein can be performed jointly by the first server and the AI system with tasks being divided between the two, or the data aggregation functions can be performed entirely by the first server or entirely by the AI system.

In step 335, the AI system can execute an AI engine to analyze the aggregated data, and generate, train, and apply one or more predictive models to the data. In some examples, the aggregated data can be used as a training dataset, for purposes of training predictive models that have been generated, and the aggregated data can be combined with previously-received data to create a larger training dataset. In some examples, the AI engine can apply one or more predictive models to predict events, such as future events and disruptions, the consequences of the same, and the likelihoods of the same. The AI system can collect and interpret the predicted events as the results of the predictive modeling performed by the AI engine.

Once the predictive modeling is complete and the results have been generated and collected, in step 340 the AI system can provide the results of the predictive modeling to the first server. In step 345, the first server can interpret the results and generate one or more notifications and/or one or more requests for response and transmit the one or more notifications and/or one or more requests for response to the user device. The one or more notifications can information the user device (or the user associated therewith) of the predicted results and of any responsive actions that will be taken in response to the results of the predictive modeling. In some examples, the user can be requested to acknowledge the responsive actions by responding to the one or more notifications. In some examples, the notifications can inform the user of the option to perform responsive actions and can request a response from the user (e.g., approval, disapproval) of each responsive action or offer the user additional information or a means to otherwise obtain additional information or ask questions about the responsive actions (e.g., a customer support email address, phone number, or web form). Accordingly, in some examples the responsive actions the user can be notified of the performance of the responsive actions and in some examples, the user can be requested to acknowledge the responsive actions by responding to the one or more notifications. In other examples, the user can be notified of potential responsive actions and be asked to approve or deny the responsive actions thereby determining which protective actions are performed. In other examples, where the one or more notifications inform the user of the responsive actions, the user can respond to the one or more notifications to rescind any responsive action that has already been performed or that is set to be performed.

In step 350, the user device can transmit one or more responses to the one or more notifications to the first server. The one or more responses can be acknowledges of the responsive actions, approvals or denials of the responsive actions, requests to rescind the responsive actions, or any combination thereof.

In step 355, the first server can perform any responsive actions within its control, and in step 360, the first server can transmit notification of any performed responsive action to the second server. For responsive actions outside of the control of the second server, the transmission in step 360 can include an instruction for the second server to perform the responsive action. Alternatively, for responsive actions outside of the control of the second server, the transmission in step 360 can include a request to the second server seeking performance of the responsive action. Thus, the first server can perform and, if necessary, coordinate performance of, any request action. In some examples, if the user has declined or rescinded any responsive actions, the first server can act accordingly, and can send a notification, instruction, or request to the second server as needed.

A responsive action can include one or more actions taken in response to the results of the predictive modeling. For example, the responsive action can be to make a change to a user's account, such as to increase or decrease a credit limit for a set period of time, to add an additional capability to the account (e.g., an additional authorized user) for a set period of time, suspend or disable the account for a period of time, or permanently close the account. The period of time over which the account changes can be in effect can also be determined by the predictive model, based on the likely duration of a predicted event or disruption. In other examples, the responsive action can be to increase security, and can include the establishment of new or different login credentials, the submission of additional identifying information, or the performance of a task. Exemplary tasks performed by the user can include, without limitation: adding or changing a password, a user name, an access code, a swipe pattern, and a security question; establishing a new form of biometric authentication; establishing multi-factor authentication by associating at least one of a telephone number, an email address, and a new client device with the account; and a combination thereof. In an embodiment, the first server can require the user to associate a telephone number, email address, or new client device that was not previously associated with the account or the user. It is understood that the specific type of authentication required may be adjusted based on the capabilities of the user's client device. The protective action can provide an additional measure of data control, and can reduce the likelihood that of hacking attacks, particularly hacking attacks based on the acquisition or capture of login credentials, will be successful.

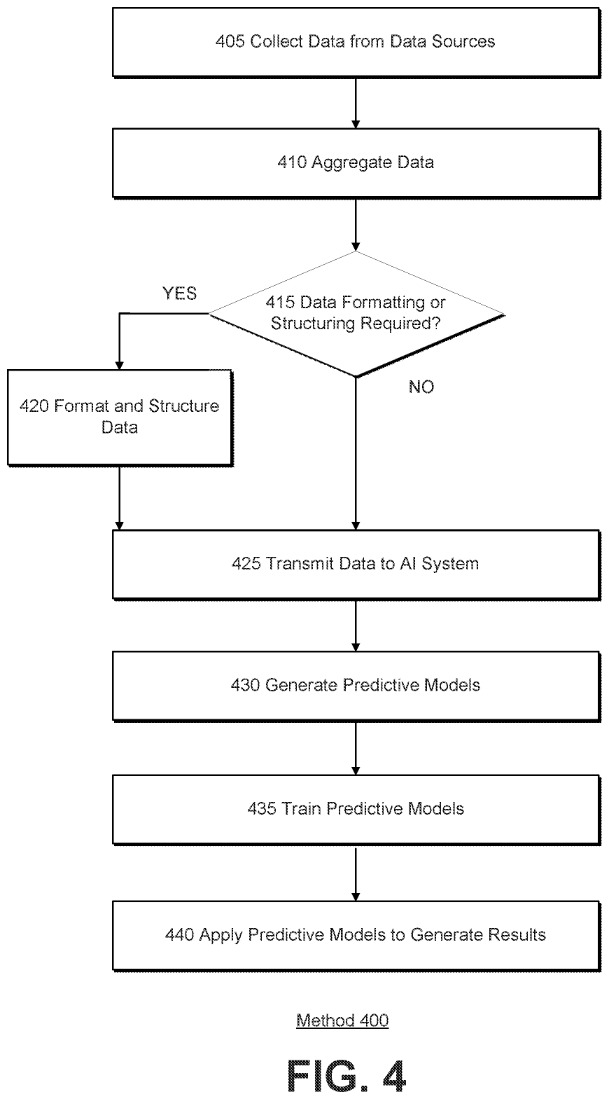

FIG. 4 illustrates a method 400 of aggregating data and performing predictive modeling. FIG. 4 can reference the same or similar components as illustrated in FIGS. 1-3.

The method 400 can commence in step 405, where data can be collected from various data sources. In some examples, a server can communicate with a user device to obtain data. The obtained data can include, without limitation, the location of the user device, identification information of an application executing on the user device, identification of the user device (e.g., device identifier, network identifier), identification of a user associated with of the user device, identification of an account associated with the user associated with the user device, any transportation data, transaction data, or activity data stored by the user device, and any combination thereof. In some examples, the server can request data from other devices, including other servers and other user devices. The requested data can include, without limitation, transportation data, transaction data, activity data, and any combination thereof. The requested data can be relevant to the information obtained from the user device, and can be stored by the other devices or otherwise accessible to the other devices, such as data stored in databases. In some examples, the request made by the server can be a direct query of one or more databases stored externally from the server or stored internally by the server.

In step 410, the server can aggregate the collected data. In some examples, this can include combining the data received from various data sources. In some examples, the received data can be combined with previously collected data. Further, since data can be stored as electronic information, files, and documents stored in various ways, including, for example, a flat file, indexed file, hierarchical database, relational database, non-relational database, and other files created and maintained with software from, for example, Oracle® Corporation, Microsoft®, and Apple®, the collected data may require formatting and structuring in a way that enables further analysis, including use by one or more predictive models. In step 415, the server can determine whether the collected data requires formatting and structuring in order to be useful for analysis. If this is required, the method 400 can proceed to step 420, wherein the collected data can be formatted and structured into a form usable for analysis, such as use in predictive model training and/or predictive modeling. Once completed, the method 400 can proceed to step 425. Returning to step 415, if the data does not require structuring and formatting in order to be useful for analysis, the method 400 can proceed directly to step 425.

In step 425, the aggregated data can be transmitting to an AI system, which may include an AI engine. In step 430, the AI engine can analyze the aggregated data, and generate one or more predictive models. The AI engine described herein can utilize BERT models, as well as CNNs and RNNs, and other machine learning techniques to generate the one or more predictive models. Examples of predictive models that can be implemented further include, without limitation, a hidden Markov model, a Gaussian mixture model, a pattern matching algorithm, a neural network, a matrix representation, (a vector quantization and decision tree, a supervised learning model, an unsupervised learning model, a semi-supervised learning model, a reinforcement learning model, a self-learning model, and a feature learning model.

In step 435, the AI engine can train the one or more predictive models. The aggregated data can be used as a training dataset, for purposes of training predictive models that have been generated, and the aggregated data can be combined with previously-received data to create a larger training dataset. In step 440, the AI engine can apply the one or more predictive models to the data. In some examples, the In some examples, the AI engine can apply one or more predictive models to predict events, such as future events and disruptions, the consequences of the same, and the likelihoods of the same.

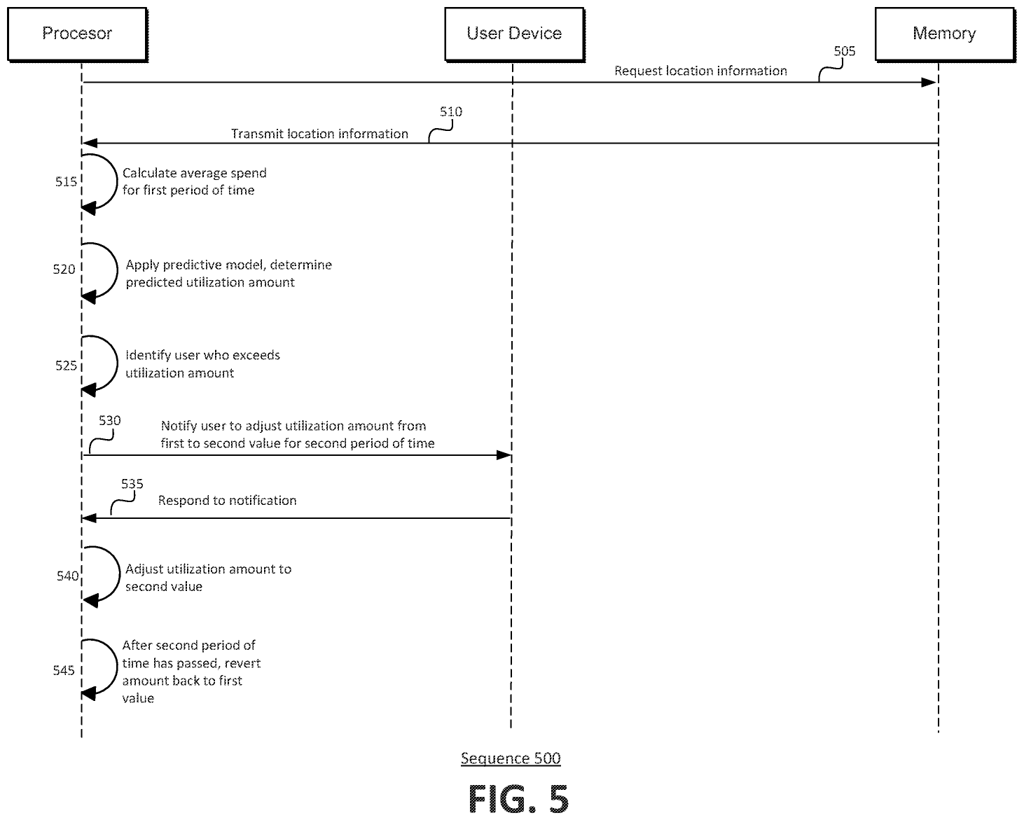

FIG. 5 is a sequence diagram illustrating a system of retrieving location information and predicting user amounts. FIG. 5 can reference the same or similar components as illustrated in FIGS. 1-4.

FIG. 5 illustrates a sequence diagram 500 according to exemplary embodiment. FIG. 5 can reference the same or similar components as illustrated in the system 100, AI system 200, sequence diagram 300, and method 400.

The sequence diagram 500 can include a memory and a processor. In step 505, the processor can be configured to retrieve location information associated with a user account. Without limitation, the memory can include the location information. In other examples, the location information can be retrieved by the processor from any device, including but not limited to from a processor external or internal to a mobile device or a server or a database. In some examples, the processor can be configured to transmit one or more requests to obtain the location information associated with a user account. For example, the mobile device or server or database can be configured to receive the one or more requests including the location information associated with the user account. Responsive to the one or more requests, the mobile device or server or database can be configured to transmit one or more responses that includes the location information associated with the user account. In some examples, the mobile device or server can be configured to transmit and receive the location information associated with the user account from the database via one or more respective requests and one or more responses. In some examples, the location information can include flight transaction data that includes route information data and travel date data.

In step 510, the processor can be configured to calculate an average spend over one or more route options for a first period of time based on the location information. For example, the processor can be configured to calculate a spend amount over any given time range, such as a predetermined time range, and derive an average spend based on the calculated spend amount over the given time range. In addition, the processor can be configured to calculate the average spend over one or more route options for a first period of time. Without limitation, the one or more route options can include a destination at a first city, a first region, or a first location and a start point including a second city, a second region, or a second location. The processor can be configured to analyze upcoming travel routes, such as less than 7 days, and search for customers that have a high credit utilization percentage, as described below.

In step 515, the processor can be configured to apply a predictive model to the average spend to determine a predicted utilization amount. For example, the predictive model can determine an amount, such as the predicted utilization amount by the user associated with user account. The determination can be developed by one or more machine learning algorithms and generated by the application of by one or more predictive models. In an embodiment, the machine learning algorithms employed can include at least one selected from the group of gradient boosting machine, logistic regression, neural networks, and a combination thereof, however, it is understood that other machine learning algorithms can be utilized.

In step 525, the processor can be configured to identify one or more users that have a user utilization amount exceeding the predicted utilization amount. In some examples, one or more users can be identified by the processor. For example, the user can have a user utilization amount that exceeds the predicted utilization amount. Without limitation, the user utilization amount can include $15,000 whereas the predicted utilization amount can include $12,000. In other examples, the user utilization mount can include $7,500 whereas the predicted utilization amount can include $5,000. It is understood that the amounts for user utilization and predicted utilization are not limited to such values, and that any other values can be used. As previously explained, the processor can be configured to analyze upcoming travel routes, such as less than 7 days, and search for customers that have a high credit utilization percentage.

In step 530, the processor can be configured to transmit one or more notifications to adjust the user utilization amount from a first value to a second value for a second period of time. For example, upon determination that the user utilization amount exceeds the predicted utilization amount, the processor can be configured to transmit one or more notifications. In particular, the one or more notifications can adjust the user utilization amount from a first value to a second value. In addition, the adjustment of the utilization amount can be for a second period of time. In some examples, the second period of time can exceed the first period of time. In other examples, the first period of time can exceed the second period of time. For example, the notification can comprise a push notification or email that alerts the user through their associated device of the average spend in a given location, such as a city, and offer to temporarily increase their credit limit while the user is traveling. In this manner, the user is prevented from getting monetarily stranded, with minimal or no access to money or funds when traveling, especially overseas which can be a high stress situation.

In step 535, the processor can be configured to receive one or more responses that are responsive to the one or more notifications. In some examples, the processor can be configured to receive one or more responses from, by way of example, a mobile device. For example, the processor or application of the mobile device can be configured to transmit one or more responses to the server. In particular, the processor or application of the mobile device can be configured to transmit one or more selections requiring approval or disapproval of the adjustment of the user utilization amount.

In step 540, the processor can be configured to adjust the user utilization amount to the second value. For example, based on the one or more responses to the one or more notifications, the processor can be configured to increase the user utilization amount to a second value. In this manner, the user utilization amount can be controlled to permit access to funds so as to allow completion of a transaction associated with the user account.

In step 545, the processor can be configured to revert the user utilization amount back to the first value. In some examples, the processor can be configured to revert the user utilization amount from the second value to the first value after expiration of the second period of time. For example, the adjustment of the user utilization amount can be valid for any number of seconds, minutes, hours, days, weeks, months, years, and/or any combination thereof upon which at the expiration of the second period of time, which can be predetermined, the processor can revert the back to the first value from the second value.

The processor can be configured to calculate an average spend for a geographic destination. In some examples, the processor can be configured to calculate an average spend for a geographic destination, such as Hawaii, California, The Bahamas, Aruba, Cancun, etc.

In some examples, the processor can be configured to train the predictive model to take into account continuous acquisition of one or more parameters to determine the average spend. Without limitation, the one or more parameters can include least one selected from the group of a zip code, prior transaction information, spending pattern information, payment debt information, point of sale information, device information, dollar conversion information, time of day, the season, gift shopping frequency and merchants, reservation expenses, transportation expenses, lodging pre-check-in expenses, downpayments and/or prepayments, and/or any combination thereof.

In some examples, the processor can be further configured to flag the user account if the user utilization amount exceeds a threshold associated with the average spend. In some examples, the processor can be configured to generate and store one or more flag after determination of the utilization amount in comparison to the average spend. For example, although the processor can be configured to permit access to the funds so as to allow completion of a transaction associated with the user account if the user utilization amount exceeds a threshold, the processor can be configured to determine if the user utilization amount is so excessive that a threshold is breached. In some examples, the processor can be configured to flag the user account if the user utilization amount of $40,000 exceeds $17,500. In other examples, the processor can be configured to flag the user account if the user utilization amount of $15,000 exceeds $5,500. In addition, the processor can be configured to log the one or more flags for each instance that the user utilization amount exceeds the threshold and generate one or more predictions that include one or more actions to be undertaken in response to exceeding the threshold for a particular user account. Without limitation, the one or more actions can include termination of the transaction, termination of the account, generation of a prompt requiring a user device response indicative of confirmation or authorization to exceed the threshold, and denial of access to funds. In some examples, any of the one or more actions can be associated with a temporal requirement, such as lasting for and up to a predetermined time prior to timing out or preventing completion of the transaction.

In some examples, the processor can be further configured to adjust the user utilization amount for at least one selected from the group of one or more merchants and one or more types of transactions. For example, the processor can be configured to increase or decrease the user utilization amount for a merchant that is within an approved list of merchants, including but not limited to a hotel, an airline, ground transportation, ride-share, a vendor, or the like. Similarly, the processor can be configured to increase or decrease the user utilization amount for a transaction that is within an approved list of transactions, including but not limited to transactions conducted at a given day/time, amount and frequency of number of transactions, and whether it is a recurring type of transaction, such as a bill or daily rental or interest rate. In some examples, the user utilization amount can be adjusted by the processor for a type of user, such as a user who has historically a high credit score and/or has generally performed reduced risk or risk-free or fraudulent-free transactions. In some examples, the processor can be configured to ascertain whether the transaction is risk-free or fraudulent-free based on calculating a risk level associated with any number of transactions.

In some examples, the processor can be further configured to decrease the user utilization amount from the first value to the second value for the second period of time. As previously explained, the processor can be configured to change or reduce the utilization amount from a first to second value up to and including the expiration time of the second period of time.

In some examples, the processor can be further configured to increase the user utilization amount from the first value to the second value for the second period of time. As previously explained, the processor can be configured to change or increase the utilization amount from a first to second value up to and including the expiration time of the second period of time.

The processor can be further configured to generate, upon completion of a transit associated with the one or more route options, one or more future preferences for the one or more users, the predictive model further taking into account the one or more future preferences to adjust the predicted utilization amount. Upon return, such as via the location information, the processor can be configured to detect the return as well as reset the credit limit for the user. In some examples, the processor can be configured to determine completion of a transit associated with the one or more options. For example, one route option can include a flight from New York to Los Angeles. Another route option can include a destination of Miami after first beginning in Denver and routing to Dallas. Yet another route option can include a destination of Chicago from Seattle before traveling back to Seattle. Any route option can be one-way or round-trip. After completion of the transit, the processor can be further configured to generate one or more preferences for the user, in which the predictive model takes into account to adjust, such as decrease or increase, the predicted utilization amount. For example, if the processor determines that a first user frequently travels to a destination via similar or same route as previously traveled, the processor can be configured to generate and save this preference information that can be applied by the predictive model in order to control the predicted utilization amount. In another example, if the processor determines that a second user infrequently travels to a destination or only occasionally travels to the destination(s), the processor can be configured to generate and save this preference information which is applied by the predictive model in order to adjust the predicted utilization amount.

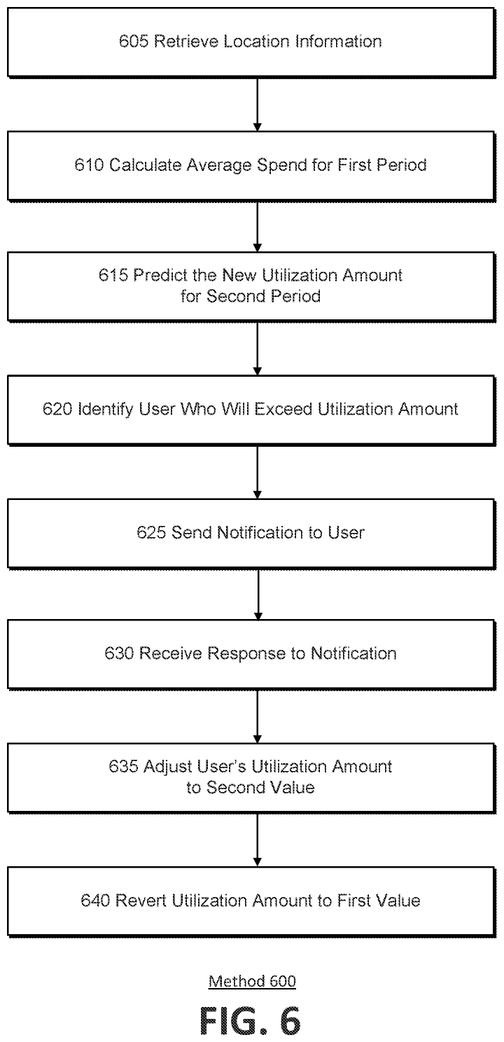

FIG. 6 illustrates a method diagram 600 according to an exemplary embodiment. FIG. 6 may reference the same or similar components of system 100, AI system 200, sequence diagram 300, method 400, and sequence diagram 500.

At block 605, the method 600 can include retrieving, by a processor, location information associated with a user account. For example, the processor can be configured to retrieve location information associated with a user account. Without limitation, the memory can include the location information. In other examples, the location information can be retrieved by the processor from any device, including but not limited to from a processor external or internal to a mobile device or a server or a database. In some examples, the processor can be configured to transmit one or more requests to obtain the location information associated with a user account. For example, the mobile device or server or database can be configured to receive the one or more requests including the location information associated with the user account. Responsive to the one or more requests, the mobile device or server or database can be configured to transmit one or more responses that includes the location information associated with the user account. In some examples, the mobile device or server can be configured to transmit and receive the location information associated with the user account from the database via one or more respective requests and one or more responses. In some examples, the location information can include flight transaction data that includes route information data and travel date data.

At block 610, the method 600 can include calculating, by the processor, an average spend over one or more route options for a first period of time based on the location information. For example, the processor can be configured to calculate a spend amount over any given time range, such as a predetermined time range, and derive an average spend based on the calculated spend amount over the given time range. In addition, the processor can be configured to calculate the average spend over one or more route options for a first period of time. Without limitation, the one or more route options can include a destination at a first city, a first region, or a first location and a start point including a second city, a second region, or a second location. For example, the processor can be configured to analyze upcoming travel routes, such as less than 7 days, and search for customers that have a high credit utilization percentage, as described below.

At block 615, the method 600 can include applying, by the processor, a predictive model to the average spend to determine a predicted utilization amount. For example, the predictive model can determine an amount, such as the predicted utilization amount by the user associated with user account. The determination can be developed by one or more machine learning algorithms and generated by the application of by one or more predictive models. In an embodiment, the machine learning algorithms employed can include at least one selected from the group of gradient boosting machine, logistic regression, neural networks, and a combination thereof, however, it is understood that other machine learning algorithms can be utilized.

At block 620, the method 600 can include identifying, by the processor, one or more users that have a user utilization amount exceeding the predicted utilization amount. In some examples, one or more users can be identified by the processor. For example, the user can have a user utilization amount that exceeds the predicted utilization amount. Without limitation, the user utilization amount can include $15,000 whereas the predicted utilization amount can include $12,000. In other examples, the user utilization mount can include $7,500 whereas the predicted utilization amount can include $5,000. It is understood that the amounts for user utilization and predicted utilization are not limited to such values, and that any other values can be used. As previously explained, the processor can be configured to analyze upcoming travel routes, such as less than 7 days, and search for customers that have a high credit utilization percentage.

At block 625, the method 600 can include transmitting, by the processor, one or more notifications to adjust the user utilization amount from a first value to a second value for a second period of time. For example, upon determination that the user utilization amount exceeds the predicted utilization amount, the processor can be configured to transmit one or more notifications. In particular, the one or more notifications can adjust the user utilization amount from a first value to a second value. In addition, the adjustment of the utilization amount can be for a second period of time. In some examples, the second period of time can exceed the first period of time. In other examples, the first period of time can exceed the second period of time. For example, the notification can comprise a push notification or email that alerts the user through their associated device of the average spend in a given location, such as a city, and offer to temporarily increase their credit limit while the user is traveling. In this manner, the user is prevented from getting monetarily stranded, with minimal or no access to money or funds when traveling, especially overseas which can be a high stress situation.

At block 630, the method 600 can include receiving, by the processor, one or more responses that are responsive to the one or more notifications. In some examples, the processor can be configured to receive one or more responses from, by way of example, a mobile device. For example, the processor or application of the mobile device can be configured to transmit one or more responses to the server. In particular, the processor or application of the mobile device can be configured to transmit one or more selections requiring approval or disapproval of the adjustment of the user utilization amount.

At block 635, the method 600 can include adjusting, by the processor, the user utilization amount to the second value. For example, based on the one or more responses to the one or more notifications, the processor can be configured to increase the user utilization amount to a second value. In this manner, the user utilization amount can be controlled to permit access to funds so as to allow completion of a transaction associated with the user account.

At block 640, the method 600 can include reverting, by the processor, the user utilization amount back to the first value. In some examples, the processor can be configured to revert the user utilization amount from the second value to the first value after expiration of the second period of time. For example, the adjustment of the user utilization amount can be valid for any number of seconds, minutes, hours, days, weeks, months, years, and/or any combination thereof upon which at the expiration of the second period of time, which can be predetermined, the processor can revert the back to the first value from the second value

The method 600 can further include calculating an average spend for a geographic destination. In some examples, the processor can be configured to calculate an average spend for a geographic destination, such as Hawaii, California, The Bahamas, Aruba, Cancun, etc.

The method 600 can further include training the predictive model to take into account continuous acquisition of one or more parameters to determine the average spend. Without limitation, the one or more parameters can include least one selected from the group of a zip code, prior transaction information, spending pattern information, payment debt information, point of sale information, device information, dollar conversion information, time of day, the season, gift shopping frequency and merchants, reservation expenses, transportation expenses, lodging pre-check-in expenses, downpayments and/or prepayments, and/or any combination thereof.

The method 600 can further include flagging the user account if the user utilization amount exceeds a threshold associated with the average spend. In some examples, the processor can be configured to generate and store one or more flag after determination of the utilization amount in comparison to the average spend. For example, although the processor can be configured to permit access to the funds so as to allow completion of a transaction associated with the user account if the user utilization amount exceeds a threshold, the processor can be configured to determine if the user utilization amount is so excessive that a threshold is beached. In some examples, the processor can be configured to flag the user account if the user utilization amount of $40,000 exceeds $17,500. In other examples, the processor can be configured to flag the user account if the user utilization amount of $15,000 exceeds $5,500. In addition, the processor can be configured to log the one or more flags for each instance that the user utilization amount exceeds the threshold and generate one or more predictions that include one or more actions to be undertaken in response to exceeding the threshold for a particular user account. Without limitation, the one or more actions can include termination of the transaction, termination of the account, generation of a prompt requiring a user device response indicative of confirmation or authorization to exceed the threshold, and denial of access to funds. In some examples, any of the one or more actions can be associated with a temporal requirement, such as lasting for and up to a predetermined time prior to timing out or preventing completion of the transaction.

The method 600 can further include adjusting the user utilization amount for at least one selected from the group of one or more merchants and one or more types of transactions. For example, the processor can be configured to increase or decrease the user utilization amount for a merchant that is within an approved list of merchants, including but not limited to a hotel, an airline, ground transportation, ride-share, a vendor, or the like. Similarly, the processor can be configured to increase or decrease the user utilization amount for a transaction that is within an approved list of transactions, including but not limited to transactions conducted at a given day/time, amount and frequency of number of transactions, and whether it is a recurring type of transaction, such as a bill or daily rental or interest rate. In some examples, the user utilization amount can be adjusted by the processor for a type of user, such as a user who has historically a high credit score and/or has generally performed reduced risk or risk-free or fraudulent-free transactions. In some examples, the processor can be configured to ascertain whether the transaction is risk-free or fraudulent-free based on calculating a risk level associated with any number of transactions.

The method 600 can further include decreasing the user utilization amount from the first value to the second value for the second period of time. As previously explained, the processor can be configured to change or reduce the utilization amount from a first to second value up to and including the expiration time of the second period of time.

The method 600 can further include increasing the user utilization amount from the first value to the second value for the second period of time. As previously explained, the processor can be configured to change or increase the utilization amount from a first to second value up to and including the expiration time of the second period of time.

The method 600 can further include generating, upon completion of a transit associated with the one or more route options, one or more future preferences for the one or more users, the predictive model further taking into account the one or more future preferences to adjust the predicted utilization amount. Upon return, such as via the location information, the processor can be configured to detect the return as well as reset the credit limit for the user. In some examples, the processor can be configured to determine completion of a transit associated with the one or more options. For example, one route option can include a flight from New York to Los Angeles. Another route option can include a destination of Miami after first beginning in Denver and routing to Dallas. Yet another route option can include a destination of Chicago from Seattle before traveling back to Seattle. Any route option can be one-way or round-trip. After completion of the transit, the processor can be further configured to generate one or more preferences for the user, in which the predictive model takes into account to adjust, such as decrease or increase, the predicted utilization amount. For example, if the processor determines that a first user frequently travels to a destination via similar or same route as previously traveled, the processor can be configured to generate and save this preference information that can be applied by the predictive model in order to control the predicted utilization amount. In another example, if the processor determines that a second user infrequently travels to a destination or only occasionally travels to the destination(s), the processor can be configured to generate and save this preference information which is applied by the predictive model in order to adjust the predicted utilization amount.

Throughout the specification, reference is made to non-typical situations. It is understood that a non-typical situation can include any situation that differs from the activities in which a user usually engages, for any amount of time. Example non-typical situations including, without limitation, travel, vacations, illness, career or job changes, academic graduations, family events, medical events, and social events.

Throughout the specification, reference is made to disruptions. It is understood that a disruption can include any unexpected event that causes a change in plans, including without limitation, a transportation delay, a transportation cancellation, a vehicle breakdown, a storm or other weather event, a natural disaster (e.g., an earthquake, flood, or tornado), and a change in laws or regulations.

As used herein, the term “merchant” can include, without limitation, retail merchants and vendors. However, it is understood that the term “merchant” is not limited thereto, and that the present disclosure can include any type of merchant, vendor, or other entity involving in activities where products or services are sold or otherwise provided, either online, in a physical location, or both.

As used herein, the term “issuing entity” can include, without limitation, financial institutions. However, it is understood that the term “issuing entity” is not limited thereto, and the present disclosure can include corporations, state, local, and federal governments, and any other entity issuing cards for use in transaction.

It is further noted that the systems and methods described herein can be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage can include random access memory (RAM) and read only memory (ROM), which can be configured to access and store data and information and computer program instructions. Data storage can also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files can be stored. The data storage of the network-enabled computer systems can include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which can include a flash array, a hybrid array, or a server-side product, enterprise storage, which can include online or cloud storage, or any other storage mechanism. Moreover, the figures illustrate various components (e.g., servers, computers, processors, etc.) separately. The functions described as being performed at various components can be performed at other components, and the various components can be combined or separated. Other modifications also can be made.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology can be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described can include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it can.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A secure prediction system, comprising:
a memory; and
a processor, wherein the processor is configured to:
retrieve location information associated with a user account,
calculate an average spend over one or more route options for a first period of time based on the location information,
apply a predictive model to the average spend to determine a predicted utilization amount,
identify one or more users that have a user utilization amount exceeding the predicted utilization amount,
transmit one or more notifications to adjust the user utilization amount from a first value to a second value for a second period of time,
receive one or more responses that are responsive to the one or more notifications,
adjust the user utilization amount to the second value, and
revert the user utilization amount back to the first value.

2. The secure prediction system of claim 1, wherein the processor is further configured to revert the user utilization amount from the second value to the first value after expiration of the second period of time.

3. The secure prediction system of claim 1, wherein the processor is further configured to calculate an average spend for a geographic destination.

4. The secure prediction system of claim 1, wherein the processor is further configured to train the predictive model to take into account continuous acquisition of one or more parameters to determine the average spend.

5. The secure prediction system of claim 4, wherein the one or more parameters includes at least one selected from a group of a zip code, prior transaction information, spending pattern information, payment debt information, point of sale information, and dollar conversion information.

6. The secure prediction system of claim 1, wherein the processor is further configured to flag the user account if the user utilization amount exceeds a threshold associated with the average spend.

7. The secure prediction system of claim 1, wherein the processor is further configured to adjust the user utilization amount for at least one selected from a group of one or more merchants and one or more types of transactions.

8. The secure prediction system of claim 1, wherein the processor is further configured to decrease the user utilization amount from the first value to the second value for the second period of time.

9. The secure prediction system of claim 1, wherein the processor is further configured to increase the user utilization amount from the first value to the second value for the second period of time.

10. The secure prediction system of claim 1, wherein the processor is further configured to generate, upon completion of a transit associated with the one or more route options, one or more future preferences for the one or more users, the predictive model further taking into account the one or more future preferences to adjust the predicted utilization amount.

11. A method of secure prediction, comprising:
retrieving, by a processor, location information associated with a user account;
calculating, by the processor, an average spend over one or more route options for a first period of time based on the location information;
applying, by the processor, a predictive model to the average spend to determine a predicted utilization amount;
identifying, by the processor, one or more users that have a user utilization amount exceeding the predicted utilization amount;
transmitting, by the processor, one or more notifications to adjust the user utilization amount from a first value to a second value for a second period of time;
receiving, by the processor, one or more responses that are responsive to the one or more notifications;
adjusting, by the processor, the user utilization amount to the second value; and
reverting, by the processor, the user utilization amount back to the first value.

12. The method of claim 11, further comprising reverting, by the processor, the user utilization amount from the second value to the first value after expiration of the second period of time.

13. The method of claim 11, further comprising calculating, by the processor, an average spend for a geographic destination.

14. The method of claim 11, further comprising training, by the processor, the predictive model to take into account continuous acquisition of one or more parameters to determine the average spend.

15. The method of claim 11, wherein one or more parameters includes at least one selected from a group of a zip code, prior transaction information, spending pattern information, payment debt information, point of sale information, and dollar conversion information.

16. The method of claim 11, further comprising flagging, by the processor, the user account if the user utilization amount exceeds a threshold associated with the average spend.

17. The method of claim 16, further comprising to adjusting, by the processor, the user utilization amount for at least one selected from a group of one or more merchants and one or more types of transactions.

18. The method of claim 16, further comprising increasing, by the processor, the user utilization amount from the first value to the second value for the second period of time.

19. The method of claim 11, further comprising generating, by the processor, one or more future preferences upon completion of a transit associated with the one or more route options, the predictive model further taking into account the one or more future preferences to adjust the predicted utilization amount.

20. A computer readable non-transitory medium comprising computer executable instructions that, when executed on a processor, perform procedures comprising the steps of:
retrieving location information associated with a user account;
calculating an average spend over one or more route options for a first period of time based on the location information;
applying a predictive model to the average spend to determine a predicted utilization amount;
identifying one or more users that have a user utilization amount exceeding the predicted utilization amount;
transmitting one or more notifications to adjust the user utilization amount from a first value to a second value for a second period of time;
receiving one or more responses that are responsive to the one or more notifications;
adjusting the user utilization amount to the second value; and
reverting the user utilization amount back to the first value.
